(19) United States
(12) Patent Application Publication
(10) Pub. No.: US 2016/0280983 A1
(43) Pub. Date: Sep. 29, 2016

(54) FLUID DIVERSION SYSTEM FOR WELL TREATMENT OPERATIONS

(71) Applicant: FTS International Services, LLC, Fort Worth, TX (US)

(72) Inventors: Frank Zamora, Fort Worth, TX (US); Mohammad Hossaini, Fort Worth, TX (US)

(73) Assignee: FTS INTERNATIONAL SERVICES, LLC, Fort Worth, TX (US)

(21) Appl. No.: 14/668,420

(22) Filed: Mar. 25, 2015

(51) Int. Cl. C09K 8/514; E21B 43/26; C09K 8/42; C09K 8/512; C09K 8/516; E21B 33/138; C09K 8/508

(52) U.S. Cl. CPC C09K 8/514; E21B 33/138; E21B 43/26; C09K 8/5086; C09K 8/512; C09K 8/516; C09K 8/426; C09K 2208/18

(57) ABSTRACT

A fluid diversion system for injection into a subterranean formation undergoing hydraulic fracturing operations. The fluid diversion system includes a carrier fluid comprising water; a cross-linked polymer; and a dispersion of “substantially insoluble” degradable bridging particulates in the carrier fluid. The degradable bridging particulates are exemplified by PLA, HEC, CMC, Guar gum, and/or HPS. When injected into a subterranean formation, the fluid diversion system is operative for diverting fluid for a predetermined period of time until degradation of the degradable components of the fluid diversion system restores permeability.

### BACKGROUND

1. Technical Field

The present invention relates to a new and novel fluid diversion system for conducting downhole operations in new or existing subterranean wellbores, and methods of use thereof, the fluid diversion system comprising degradable particulate bridging material and a low residue, cross-linked polymer in an aqueous media. Specifically, in a preferred embodiment, the invention relates to the use of a combination of hydroxyethyl cellulose (hereinafter “HEC”) gel, solid polylactic acid (hereinafter “PLA”) and solid HEC in a fluid diversion system to create a fully degradable, impermeable barrier or plugging mechanism that is useful, as a fluid diversion system, for conducting hydraulic fracturing operations, re-fracturing operations, and/or perforating operations.

2. Background of the Invention

Hydraulic fracturing, one example of a downhole operation, is a technique that has revolutionized the oil and gas industry. Hydraulic fracturing is used to enhance the production of hydrocarbons from subterranean formations. For instance, hydraulic fracturing techniques now allow operators to produce gaseous and liquid hydrocarbons from certain shale formations that were once thought to be too impermeable to economically produce.

Hydraulic fracturing typically uses a subterranean treatment fluid or fracturing fluid that is injected into a wellbore at high pressure in order to create or extend cracks in the deep-rock formations through which oil or gas can then flow more freely. A viscous treatment fluid is typically used in fracturing operations. High pressure pumps are used at the surface to pump the treatment fluid down the wellbore and into the formation at a high enough rate to exert a sufficient hydraulic pressure within the formation to create and/or extend fractures therein.

The viscous fracturing fluid typically includes suspended proppant particles, such as sand or bead material (e.g., plastic or ceramic beads of a predetermined size), that migrate through and are deposited into the formation fractures. The deposited proppant prevents the fractures from fully closing once the hydraulic pressure created by the fracturing operation has achieved equilibrium and is then released. As a result, conductive channels having increased surface areas are formed within the formation through which hydrocarbons can flow toward the well bore for production.

Certain sized particulates of a degradable particulate bridging material may be included in a fluid diversion system in order to divert the treatment fluid toward desired areas within the formation. For instance, it may be desirable to promote far-field diversion or near-wellbore diversion in order to create a differential pressure that is sufficient to allow hydraulic fracturing of another section of the formation. The fluid diversion system that is introduced in one section of a subterranean formation will slow and then prevent the flow of further fluid into that area, thus diverting later-placed fluid to other sections of the formation that are to be fractured. The fluid diversion system can help maintain the pressure of the fracturing operation by reducing the permeability, and thus fluid flow, into some areas of the formation in order to maintain the pressure needed to fracture other areas of the formation.

Often times, an operator must use tools that are deployed into the wellbore, for instance by either wireline, coiled tubing, or jointed pipe, to perform hydraulic fracturing operations in new or existing wells. Hydraulic fracturing operations that involve deploying downhole tools into the wellbore can be time-consuming or may even result in lost tools that must be retrieved through what is known as a fishing operation, all of which can be costly to the operator. A lost tool that cannot be retrieved may require expensive remedial measures or even result in the loss of an entire well, for which the operator has made a substantial investment. Thus, it is desirable to avoid wellbore intervention with tools to conduct hydraulic fracturing operations whenever possible. Ideally, whenever a barrier is needed downhole to control fluid flow or to divert fluids while conducting fracturing operations in new or existing subterranean wellbores, it would be preferential to use a fluid diversion system rather than downhole tools.

Oil and gas wells that are drilled to recover hydrocarbons from shale formations, for instance, often have steep decline curves, meaning that the production rates for such wells decline more rapidly over time in comparison to production rates for conventional wells drilled into sandstone formations. As a result, operators often elect to re-frac existing wells drilled in shale formations to access untapped zones through which the wellbore has been drilled. In order to frac a new zone or reservoir in an existing cased well, the portion of the wellbore that was previously perforated must be sealed off through the use of a barrier to perforate an unperforated interval of casing and then fracture the new zone or reservoir proximate the new perforations. Operators typically deploy tools into the wellbore to create such a barrier and then perforate an unperforated interval and/or divert the fracturing fluid to the new zone or reservoir. For instance, the operator may use and deploy an open-hole packer or a removable (e.g., drillable) plug to create a barrier downhole during the perforating operations and/or during hydraulic fracturing of a new zone or reservoir.

When drilling and completing certain new wells, operators often elect to deploy elaborate and costly completion systems that include downhole flow control tools (such as sliding sleeves and inflow control devices) and downhole isolation tools (such as annular barrier tools, packers, and composite frac plugs) for selectively fracturing portions of a hydrocarbon-bearing formation (whether multiple regions of a single production zone or multiple zones or reservoirs) through which the wellbore has been drilled. New wells can be completed as open-hole wells or open wellbores (i.e., there is no liner or casing in the wellbore proximate the formations or zones to be produced) or as cased-hole wells or cased wellbores (i.e., a liner or casing is cemented in place within the wellbore proximate the production zones). Such completion systems may be designed to include sliding sleeves, annular barriers, and/or packers that are deployed on a completion string and used in isolating and fracturing different zones. In such systems, operators elect to produce certain zones first and then must later intervene with balls or tools to shift the sleeves in the production string. For some wells, it is simply not economical to employ the use of such a complex and costly completion system. For other wells, it would be preferable, if at all possible, to avoid the cost of such an elaborate system.

### SUMMARY

An exemplary embodiment of the present invention relates to a fluid diversion system for conducting downhole operations in new or existing subterranean wellbores using a dispersion of a degradable particulate bridging material in an aqueous carrier fluid that includes a and a low residue, cross-linked polymer. The fluid diversion system is useful for fluid diversion during hydraulic fracturing operations and/or perforating operations in wellbores drilled through subterranean formations.

An exemplary embodiment provides a fluid diversion system for injection into a subterranean formation undergoing hydraulic fracturing operations, the fluid diversion system includes a carrier fluid comprising water and a dispersion comprising substantially insoluble, degradable bridging particulates in the carrier fluid. When injected into a subterranean formation, the fluid diversion system is operative for a predetermined period of time until degradation of the substantially insoluble, degradable bridging particulates.

Optionally, the fluid diversion system comprises from about 1 wt. % to about 50 wt. % of substantially insoluble, degradable bridging particulates. Optionally, the substantially insoluble, degradable bridging particulates includes HEC particulates.

Further optionally, the fluid diversion system includes from about 1 wt. % to about 50 wt. % of substantially insoluble, degradable bridging particulates of PLA.

Yet further, optionally, the fluid diversion system includes from about 1 wt. % to about 50 wt. % of substantially insoluble, degradable bridging particulates where the particulates include HEC particulates and PLA particulates.

Optionally, the substantially insoluble, degradable bridging particulates of the fluid diversion system are in the size range from about 50 to about 4,000 microns.

Yet further optionally, the fluid diversion system further includes sand.

A further alternative exemplary embodiment provides a method of timed fluid diversion in a subterranean formation, the method comprising steps of selecting a fluid diversion system comprising a carrier fluid comprising water and a dispersion in the carrier fluid, wherein the dispersion includes substantially insoluble, degradable bridging particulates. The method further includes injecting the selected fluid diversion system into the subterranean formation to cause fluid diversion in the subterranean formation; producing from the subterranean formation; and allowing the elapse of time sufficient for the injected substantially insoluble, degradable bridging particulates to degrade under conditions in the subterranean formation.

Optionally, the exemplary method of timed fluid flow control, fluid diversion, or plugging off of fractures includes selecting a pre-formulated fluid diversion system, where the pre-formulated fluid diversion system is prepared remotely from a site where the step of injecting the fluid into a subterranean formation is performed.

Further optionally, the method of timed fluid flow control, fluid diversion, or plugging off of fractures includes selecting a fluid diversion system comprising from about 1 wt. % to about 50 wt. % of the substantially insoluble, degradable bridging particulates. Optionally, the fluid diversion system further comprises HEC cross-linked polymer.

Optionally, the exemplary method of timed fluid flow control, fluid diversion, or plugging off of fractures includes selecting a fluid diversion system comprising from about 1 wt. % to about 50 wt. % of substantially insoluble, degradable bridging particulates of PLA. Optionally, and alternatively, the fluid diversion system includes from about 1 wt. % to about 50 wt. % of HEC bridging particulates. Further optionally, and alternatively, the fluid diversion system comprises from about 1 wt. % to about 50 wt. % of substantially insoluble, degradable bridging particulates, said particulates including both HEC particulates and PLA particulates. Optionally, the carrier fluid includes HEC polymer.

Optionally, the method of timed fluid flow control, fluid diversion, or plugging off of fractures includes substantially insoluble, degradable bridging particulates in the size range from about 50 to about 4,000 microns. Optionally, degradation of the substantially insoluble, degradable bridging particulates takes place over a predetermined period of time in the range from about 8 to about 120 hours.

More particularly, an exemplary embodiment of the present invention relates to a fluid diversion system comprising a suspension or dispersion of substantially insoluble, degradable bridging particulates (exemplified by PLA, HEC, carboxy-methyl cellulose (“CMC”), Guar gum, “insoluble” or high performance starches (“HPS”), and the like) in an aqueous fluid that includes a high viscosity cross linked polymer, such that when injected into a subterranean formation, the substantially insoluble, degradable bridging particulates create an impermeable barrier across existing fractures or existing perforations of the formation. The fluid diversion system is useful as a fluid diverting agent, for conducting hydraulic fracturing operations and/or perforating operations, whether such operations are performed in open or cased wellbores or in new or existing wellbores.

An alternative exemplary embodiment of the present invention provides a method of diverting fracturing fluid during a fracturing operation for creating fractures in a formation. This embodiment includes providing a fluid diversion system comprising a carrier fluid, having an HEC cross-linked polymer and carrying a dispersion of substantially insoluble, degradable HEC and PLA bridging particulates. This fluid diversion system is introduced into a portion of a subterranean formation that was previously fractured to bridge across and plug existing fractures or perforations in the casing to allow fracturing fluid to be pumped into the wellbore at a pressure sufficient to create or extend at least one new fracture in the formation. The substantially insoluble, degradable HEC particulates and PLA particulates initially form a bridge across and plug the existing near well-bore fractures and/or the existing far-field fractures within the formation and/or the perforations in the casing, allowing fracturing fluid to be diverted to other zones of the formation to create at least one new fracture in the formation. The substantially insoluble, degradable HEC particulates and PLA particulates of the fluid diversion system degrade over time as the temperature of the particulates in the subterranean formation increases and/or as lactic acid molecules from the PLA are released into solution, reestablishing the permeability of the portion of the subterranean formation with the pre-existing fractures to later (1) allow a treatment fluid to penetrate or leak off into that portion of the subterranean formation and/or (2) produce hydrocarbons from that portion of the formation.

Another alternative exemplary embodiment of the present invention provides a method of diverting fracturing fluid during a fracturing operation for creating new fractures in a formation that was previously fractured. This alternative embodiment includes providing a fluid diversion system comprising a carrier fluid having an HEC cross-linked polymer and substantially insoluble, degradable bridging particulates in a range of sizes. The sized substantially insoluble, degradable bridging particulates of the fluid diversion system may be solely PLA, solely HEC, solely CMC, solely Guar gum, solely high performance starches (“HPS”), or solely another insoluble starch or polymer, or a combination of any two or more of the foregoing. Accordingly, the fluid diversion system may comprise different sized HEC particulates that are used in combination with the carrier fluid having an HEC cross-linked polymer. Alternatively, the fluid diversion system may comprise different sized PLA and/or HEC and/or CMC and/or Guar gum and/or HPS particulates and/or particulates having similar characteristics and/or functionality that are used in combination with the carrier fluid which includes an HEC cross-linked polymer. This fluid diversion system is introduced into a portion of a subterranean formation that was previously fractured to bridge across and plug existing fractures or perforations in the casing to allow fracturing fluid to be pumped into the wellbore at a pressure sufficient to create or extend at least one new fracture The substantially insoluble, degradable bridging particulates of different sizes provide fluid diversion in a portion of the subterranean formation by initially forming a bridge across and plugging the existing near well-bore fractures and/or the existing far-field fractures within the formation, allowing fracturing fluid to be diverted to other zones of the formation to create at least one new fracture in the formation. The substantially insoluble HEC and particulates degrade over time as the temperature of the fracturing fluid in the subterranean formation increases, reestablishing the permeability of the portion of the subterranean formation with the pre-existing fractures to later (1) allow a treatment fluid to penetrate or leak off into that portion of the subterranean formation and/or (2) produce hydrocarbons from that portion of the formation.

Another alternative exemplary embodiment of the present invention provides a method of conducting re-fracturing operations in a wellbore drilled through a production zone of a subterranean formation, with the wellbore being lined with a liner proximate the production zone. The method of conducting re-fracturing operations comprises the steps of selecting a fluid diversion system comprising a carrier fluid and a dispersion therein of substantially insoluble, degradable bridging particulates; pumping the fluid diversion system into the wellbore and into a plurality of pre-existing perforations located in a first section of the liner proximate a first region of the production zone; and plugging the plurality of pre-existing perforations in the first section of liner with the fluid diversion system. A second section of the liner is perforated to create a plurality of new perforations located in a second section of the liner and then fractures are initiated within a second region of the production zone by pumping fluid through the plurality of new perforations and into the second region of the production zone. When pumped into the plurality of pre-existing perforations, the fluid diversion system is operative for plugging the pre-existing perforations for a predetermined period of time until degradation of the substantially insoluble, degradable bridging particulates.

Another alternative exemplary embodiment of the present invention provides a method of conducting re-fracturing operations in an open wellbore drilled through a production zone of a subterranean formation having pre-existing fractures. The method of conducting re-fracturing operations comprises the steps of selecting a fluid diversion system comprising a carrier fluid and a dispersion therein of substantially insoluble, degradable bridging particulates; pumping the fluid diversion system into the wellbore and into the pre-existing fractures located in the production zone; and plugging the plurality of pre-existing fractures located in the production zone with the fluid diversion system. New fractures are initiated within the production zone by pumping fluid into the production zone. When pumped into the plurality of pre-existing fractures, the fluid diversion system is operative for plugging the pre-existing fractures for a predetermined period of time until degradation of the substantially insoluble, degradable bridging particulates.

Another alternative exemplary embodiment of the present invention provides a method of conducting multi-stage fracturing operations in a wellbore drilled through a subterranean formation and lined with a liner. The method of conducting multi-stage fracturing operations comprises the steps of perforating a first section of the liner to create a first set of perforations in the liner; initiating fractures within the subterranean formation proximate the first set of perforations in the liner by pumping fluid through the first set of perforations and into a first region of the subterranean formation proximate the first set of perforations; selecting a fluid diversion system comprising a carrier fluid and a dispersion therein of substantially insoluble, degradable bridging particulates; and pumping a volume of the fluid diversion system into the wellbore and into the first set of perforations located in the first section of the liner to plug the first set of perforations in the first section of the liner with at least a portion of the fluid diversion system. A second section of liner is perforated to create a second set of perforations in the liner and fractures are initiated within the subterranean formation proximate the second set of perforations in the liner by pumping fluid through the second set of perforations and into a second region of the subterranean formation proximate the second set of perforations. When pumped into the first set of perforations, the fluid diversion system is operative for plugging the first set of perforations for a predetermined period of time until degradation of the substantially insoluble, degradable bridging particulates.

The foregoing is but a brief summary of exemplary embodiments of the present invention. Other features and advantages will be readily apparent to those skilled in the art upon a reading of the detailed description of the exemplary embodiments here below.

### BRIEF DESCRIPTION OF THE DRAWINGS

The novel features believed characteristic of the invention are set forth in the appended claims. The invention itself, however, as well as a preferred mode of use and further objectives and advantages thereof, will be best understood by reference to the following detailed description of illustrative embodiments when read in conjunction with the accompanying drawings, wherein:

FIG. 1 is a schematic representation of a high pressure/high temperature test apparatus used in testing and demonstrating the effectiveness of alternative exemplary embodiments of a fluid diversion system.

FIG. 2 is schematic representation of a variable frac slot, which is a component of a high pressure/high temperature test apparatus illustrated in FIG. 1, which is used in testing and demonstrating the effectiveness of alternative exemplary embodiments of a fluid diversion system.

FIG. 3 illustrates a portion of a subterranean wellbore that was drilled through a production zone, cased, and perforated and depicts the use of an exemplary embodiment of a fluid diversion system for re-fracturing a production zone that was previously fractured.

FIG. 4 illustrates a portion of a subterranean wellbore having a horizontal portion that was drilled through a production zone and completed as an open wellbore and depicts the use of an exemplary embodiment of a fluid diversion system for re-fracturing the production zone that was previously fractured.

FIG. 5 illustrates a portion of a subterranean wellbore that was drilled through a production zone, cased, and perforated and depicts the use of an exemplary embodiment of a fluid diversion system for use in perforating a new section of the cased wellbore and fracturing a new region of the production zone.

### DETAILED DESCRIPTION

Exemplary embodiments of the present invention relate to fluid diversion systems useful for hydraulic fracturing operations and perforating operations in subterranean formations. More particularly, exemplary embodiments of the present invention relate to methods of using particulates of substantially insoluble, degradable compositions and PLA particulates suspended in a high viscosity cross-linked polymer solution for fluid diversion during hydraulic fracturing operations and perforating operations. In a preferred embodiment, the high viscosity cross-linked polymer solution comprises HEC gel.

According to exemplary embodiments of the present invention, there are provided methods of use of a fluid diversion system that allows an operator to design a fracture and completion protocol for a subterranean well in which the operator initially fractures and produces from one or more zones and then can isolate, for a period of time, the initially produced zones while other zones are fractured. In such an exemplary fluid diversion system, a barrier must be created and remain in place during subsequent fracturing operations.

In open-hole wells (also called open wellbores), such a fluid diversion system must close off and create a barrier across the fractures that were previously created in the producing (or production) zones, holding pressure to allow the diverted fracturing fluid to fracture new zones. In cased wellbores, such a fluid diversion system must close off and create a barrier across the previous perforations that were made in the casing proximate the production zones, holding pressure to allow the diverted fracturing fluid to fracture new zones.

In exemplary embodiments of the fluid diversion system, the fluid diversion system poses little or no risk to the environment, and components of the fluid diversion system are able to degrade over time and restore lost permeability. Ideally, the fluid diversion system, according to the exemplary embodiment of the present invention, includes materials that are commercially available and that, in combination, provide the desired suspension and bridging properties for the particular application of the fluid system.

An exemplary embodiment of the fluid diversion system of the present invention includes a substantially insoluble, degradable particulate bridging material within a range of size distributions selected to reduce fracture permeability, as required for diversion and/or plugging functions. In addition, in an exemplary embodiment, the fluid diversion system includes a low residue, cross-linked polymer as a component of the carrier fluid for the bridging material, wherein the low residue, cross-linked polymer is present in sufficient concentration to seal off residual permeability in the emplaced bridging material and allow the fluid diversion system to perform its function. In the exemplary embodiments, the term “low residue” as it refers to the cross-linked polymer component means having less than about 1 wt. % residue.

An exemplary embodiment of the fluid diversion system may be a dispersion of degradable particulate bridging material (and optionally with addition of natural bridging material such as sand) in a carrier fluid that includes a low residue, cross-linked polymer. The dispersion may be prepared off-site, for convenience and minimization of equipment and labor at the well, at a location remote from the well where the fluid diversion system is to be injected. Furthermore, an exemplary embodiment of the fluid diversion system may be modified on the fly at the well site based on downhole conditions that are encountered and results obtained during treatment operations.

An exemplary embodiment provides a fluid diversion system for injection into a subterranean formation undergoing hydraulic fracturing operations. The fluid diversion system includes a carrier fluid comprising water; a cross-linked polymer; and a dispersion of substantially insoluble, degradable bridging particulates. The substantially insoluble, degradable bridging particulates, such as for example PLA, HEC, CMC, Guar gum, or HPS, act as bridging agents for a pre-selected period of time. Thus, when injected into a subterranean formation, the fluid diversion system is operative as a diversion fluid for a predetermined period of time, until degradation of the substantially insoluble, degradable bridging particulates of the fluid diversion system. While not being bound by any theory, it is theorized that upon injection of the diversion fluid, the permeability of the fractures within the subterranean formation is reduced by the substantially insoluble, degradable bridging particulates acting as temporary bridging agents, which are forced into the fractures due to the pressure differential between the wellbore and the formation. The high-viscosity cross-linked polymer may further seal off permeability. Once the fractures are substantially completely sealed off by the fluid diversion system, re-fracturing and/or perforating operations may then be conducted downhole. Upon elapse of a period of time, the substantially insoluble, degradable particulate components of the diversion fluid will degrade to such an extent that subterranean formation permeability increases and is restored.

An exemplary embodiment of the invention uses hydroxyethyl cellulose (also referred to as hydroxy ethyl cellulose and hydroxyethylcellulose) as the high viscosity cross-linked polymer carrier fluid. Hydroxyethylcellulose is referred to herein as “Cross-linked HEC”. HEC itself has no adverse effect on the reservoir, but is too elastic, on its own, to plug any fluid passages. It does, however, have the general characteristics of water-fracturing fluids, such as the strong capability to suspend temporary bridging agents and proppants and also limit fluid friction. A water-based carrier fluid that uses HEC as the cross-linking polymer has almost no residue after liquefaction and is particularly suitable for the low-permeability strata that cannot readily discharge residue. Under alkaline conditions, a fluid diversion system comprising a water-based carrier fluid made with HEC may form complexes with such solutions as magnesium chloride, copper chloride, copper nitrate, copper sulfate, and dichromate, and is especially useful for plugging porous media, depleting zones, and unwanted fractures. Furthermore, due to its high viscosity, a water-based carrier fluid made with HEC is useful for suspending the dispersion of substantially insoluble, degradable bridging particulates that act as temporary bridging agents. Further, HEC minimizes the potential loss of viscosity caused by high downhole temperatures. It has shown good viscosity maintaining capabilities in downhole operations, even at above about 200° F.

HEC can be used as the viscosity agent in brines and saline carrier fluids, fracturing fluids, work over fluids, completion fluids and drill-in fluids. It gives pseudo-plastic rheology, but little or no gel strength development. HEC offers little fluid flow control, other than its rheological effects.

In a typical manufacture of HEC, cellulose fibers react with caustic soda and ethylene oxide to form the HEC compound. Hydroxy ethyl groups attach to the hydroxyl (“OH”) groups of the polysaccharide structure by ether linkages. HEC is nonionic, is not precipitated by hardness ions, and disperses well at high salinity. HEC is not degraded by common bacteria.

The substantially insoluble, degradable bridging particulates of the diversion fluid may be selected from a wide variety of compositions. The requirements are “substantial insolubility,” in an aqueous fluid and hydrocarbon environment and predictable degradability over a period of time. The term “substantially insoluble, degradable particulate” includes particulate compositions that either (1) have a low solubility in an aqueous medium but that will dissolve over time under subterranean conditions; or (2) that are insoluble in water but that gradually react with water (of an aqueous carrier fluid or components of a subterranean formation) over time under subterranean conditions to degrade their particulate nature by becoming soluble or otherwise breaking down due to chemical reaction (i.e. by “solubilizing”). Clearly, subterranean conditions such as temperature play a significant role in the rate of dissolution or reacting away (solubilization) of the particulates. Accordingly, the size range and composition of the substantially insoluble, degradable bridging particulates are selected for maintaining bridging properties for the desired period of time under the operative subterranean conditions, after which time the particulates should degrade and no longer perform any bridging or diversion function due to either being dissolved or reacted away. The term “substantially insoluble” is exemplified by PLA, solid HEC, CMC, Guar gum, and HPS. Aside from HEC and PLA particulates, embodiments may therefore also use in addition, or instead, particulates of CMC, Guar gum, HPS and like degradable compositions that are likewise substantially insoluble in aqueous fluid, but that can either dissolve or can be solubilized, as described herein.

Polylactic acid, or Polylactide (“PLA”) is a degradable thermal plastic aliphatic polyester derived from renewable resources, such as corn starch, tapioca roots, chips or starch, or sugar cane. PLA particulates may be in the form of small balls or beads or other shapes that can mimic the functionality of sand that might otherwise be used in a fracturing or re-fracturing operation, albeit that sand is an optional additional component of the present fluid diversion system. Because the diversion fluid system is designed to be operative for a period of time, and because the operative period of time depends upon the rate of degradation of the particulates and may also depend on the particulate size range, the particulate composition and sizing is selected to be operative for a predetermined time period after which the particulates either dissolve or otherwise lose their particulate integrity and no longer serve a bridging function.

The sizes for the HEC and PLA particulates in the exemplary embodiment of the present invention are selected depending on the conditions in the subterranean formation and the particular operation in which the fluid diversion system is used, such as for plugging formation fractures (whether near-well fractures or far-field fractures) or plugging perforations in casing. The selection of the substantially insoluble, degradable bridging particulates and the fluid diversion system for a desired use depends on a number of factors including (1) the rate of degradation of the chosen substantially insoluble, degradable bridging particulates, (2) the particle size of the substantially insoluble, degradable bridging particulates, (3) the pH of the fluid diversion system, (4) the design temperature, and (5) the loading of the substantially insoluble, degradable bridging particulates in the fluid diversion system. As used herein the term “design temperature” refers to an estimate or measurement of the actual temperature at the downhole environment at the time of the treatment. That is, design temperature takes into account not only the bottom hole static temperature (“BHST”), but also the effect of the temperature of the fluid diversion system on the BHST during treatment. Because fluid diversion systems may be considerably cooler than the BHST, the difference between the two temperatures can be quite large.

While a wide range of quantity of substantially insoluble, degradable bridging particulates in the fluid diversion systems is possible, and is contemplated, exemplary embodiments of the fluid diversion system may include at least the following components by weight percentage in order to form a stable, useful suspension:
from about 1 wt. % to about 50 wt. % substantially insoluble, degradable bridging particulates (such as PLA, HEC, CMC, Guar gum, HPS and the like); and
from about 10 wt. % to about 75 wt. % cross-linked polymer.
   Optionally, the fluid diversion system may also include from about 1 wt. % to about 50 wt. % HEC polymer gel. And, further optionally, the fluid diversion system may include sand and/or another inert proppant.

A further exemplary embodiment of the fluid diversion system may include at least the following components by weight percentage:
from about 0.25 wt. % to about 3 wt. % substantially insoluble, degradable bridging particulates (such as PLA, HEC, CMC, Guar gum, HPS and the like); and
from about 3 wt. % to about 25 wt. % cross-linked polymer.
   Optionally, the fluid diversion system may also include from about 0.25 wt. % to about 10 wt. % HEC polymer gel. And, further optionally, it may include sand and/or another inert, insoluble proppant.

The size ranges of the particulate components that are the bridging material components of the fluid diversion systems are selected based on several criteria, including the extent to which permeability must be reduced, the nature of the formation and its permeability, the anticipated widths of the fractures that are pre-existing within the formation, the sizes of the existing perforations in the wellbore casing, the desired time period during which the fluid diversion system must be operative, and/or the degree of insolubility of the particulates or the rate of particulate degradation under subterranean conditions. Typically, when pumping particles through openings, such as small fractures and the exposed pore space within formations, bridging of the particles across the openings will occur when the diameter of the particles are ⅕ or more of the size of the opening or fracture. When bridging occurs, the permeability through the openings is reduced. The openings are sealed and permeability is effectively eliminated by the cross-linked polymer gel. Taking these factors into account, in general, for example, the size ranges are selected for plugging a formation would include a first size range for one component that is relatively large, with a second size range of another component that is smaller, and a third yet smaller size range for a third component. The relative amounts of each of the components are also selected such that the three sizes and relative amounts provide randomly a closely packed arrangement to provide an adequate bridge across the existing fractures and pore space within the formation, temporarily plugging off flow into the formation and eliminating the permeability of this portion of the formation. Selecting a higher proportion of a degradable material rather than sand would, of course, allow restoration of the pre-operation permeability as the degradable material degrades. The size range of the degradable material might affect the time period for degradation (larger sized particulates take longer to degrade (solubilize or dissolve), for example), and this allows customizing for particular purposes.

Exemplary embodiments of the present invention provide improved methods of providing temporary diversion of fracturing fluids in subterranean production zones penetrated by well bores. The methods include placing a fluid diversion system comprising a substantially insoluble, degradable particulate, such as particulate HEC (or PLA, CMC, Guar gum, or HPS or the like), in a subterranean formation so that such solids create a physical barrier to fluid flow (such as by blocking pore throats in a formation or by filling an annulus area) and then allowing the solids to degrade over time to remove the physical barrier. The substantially insoluble, degradable particulate (PLA, HEC, CMC, Guar gum or HPS or the like) degrades or dissolves in the presence of an aqueous fluid in contact therewith and, once removed, fluids within the formation again flow freely.

The use of PLA particulates in conjunction with other substantially insoluble, degradable bridging particulates has advantages. For example, solubilization of PLA particulates takes place commencing at the outer surface of the particulates where surface PLA reacts with water over time to form lactic acid. The lactic acid molecules that are released into the carrier fluid speed up the degradation of other substantially insoluble, degradable bridging particulates that may also be deployed in the fluid diversion system, such as PLA, HEC, CMC, Guar gum and/or HPS particulates.

As indicated above, the compositions suitable for use as the substantially insoluble, degradable bridging particulates in the present invention include, but are not limited to, slowly degradable bridging particulates that lose their particulate nature either through dissolution or reaction over time in the subterranean environment. These materials include, but are not limited to, PLA, HEC, CMC, Guar gum, HPS, and the like. These materials are only slightly soluble in water at room temperature; however, with time and under temperature conditions in the subterranean zone, the particulate materials either dissolve or react with the surrounding aqueous fluid and are solubilized. As used in this context, the term “solubilized” means that a composition such as PLA is chemically altered by reaction to become more readily soluble in an aqueous medium. The reaction products of the solubilized PLA (e.g. lactic acid), being more soluble in water as compared to the PLA particulate solid materials, may dissolve in an aqueous fluid. The total time required for the PLA particulate solid materials in the subterranean zone to degrade and dissolve in an aqueous fluid is generally in the range of from about 8 hours to about 72 hours depending upon the temperature of the subterranean zone in which they are placed. (Of course, other selected particulate compositions may degrade more rapidly, or more slowly under in situ conditions; for example, in the range from about 8 to about 120 hours.) The reaction products of the solubilized PLA (e.g. lactic acid) may in turn act as a “breaker” for the cross-linked polymer of the carrier fluid, such as HEC polymer. This occurs because the formation of lactic acid causes the fluid pH to drop to an acidic range, potentially to even less than about pH 4. This low pH will accelerate the break-up of the HEC cross-linking polymer.

The substantially insoluble, degradable bridging particulate dispersion in the carrier fluid is placed in a subterranean zone by injecting the fluid diversion system into the wellbore proximate the subterranean zone of interest. The fluid diversion system dissipates into the subterranean zone through openings, which may be naturally-occurring (cracks, fractures, and fissures) or a man-made annulus that is formed between nested pipes or between a well bore and a pipe (well bores, perforations, and fractures). As the fluid diversion system is placed, the substantially insoluble, degradable bridging particulates are screened out of the fluid diversion system by the formation and are thereby randomly packed into the openings based on the selected size ranges of the particulates. Depending upon the size ranges selected and other factors, as explained herein, the fluid diversion system can be used for temporary fluid diversion or temporary plugging.

In exemplary fluid diversion systems, regardless of whether the substantially insoluble, degradable bridging particulates serve functionally as a fluid diverting agent or a plugging agent, a variety of carrier fluids can be used for packing the openings including, but not limited to, carrier fluids comprising fresh water, salt water, brine (saturated salt water), seawater, produced water (subterranean formation water brought to the surface), surface water (such as lake or river water), and flow back water (water placed into a subterranean formation and then brought back to the surface). In some embodiments mine drainage water may also be used. In general, any water can be used as a component of a carrier fluid as long as it is compatible with the particular reservoir formation.

When the fluid diversion system is used in a hydraulic fracturing operation, a frac-packing operation, gravel packing operation, or some other operation used to either place particulates or stimulate the formation, the fluid diversion system will generally be made more viscous through the use of a viscosifier (“viscosity enhancing agent”), comprising one or more high viscosity cross-linked polymers. As already mentioned above, in a preferred embodiment, HEC polymer may be used for this purpose. The viscosifier also facilitates the creation of a dispersion of particulates in the carrier fluid.

A significant advantage of the fluid diversion systems is that the substantially insoluble, degradable bridging particulates that act as a bridging agent are selected to degrade over a period of time in the subterranean zone. Since the particulates are selected to degrade over a period of time, and to have a limited operative life as bridging agents, this eliminates the need to subsequently carry out steps to contact the subterranean zone with clean-up fluids or additional breakers to remove the diversion/bridging material and restore permeability.

As mentioned here above, the selection of the proper size for the substantially insoluble, degradable particles (e.g., PLA, HEC, CMC, Guar gum and/or HPS) is related in part to the size of the formation fractures formation pores, or the perforations in the casing. Suitable sizes can range from one micron to as large as 6.0 U.S. Mesh (3,353 microns). In some preferred embodiments, the particulates are sized from about 1 to more than about 150 microns.

The solubility of the substantially insoluble, degradable bridging particulates can be affected by the pH of the fluid diversion system, by the design temperature, and by the selection of the substantially insoluble, degradable bridging particulates. To allow for relatively slow solubility, exemplary embodiments of the fluid diversion systems of the present invention are preferably pH neutral or below.

In accordance with exemplary embodiments, the fluid diversion systems generally comprise a carrier fluid and substantially insoluble, degradable bridging particulates that act as a fluid diverting agent or a plugging agent as noted before. The fluid diversion system may be aqueous, non-aqueous, foamed, or an emulsion.

In alternative exemplary embodiments, the fluid diversion system may be a foamed fluid (e.g., a liquid that comprises a gas). Any suitable gas may be used for foaming, including nitrogen, carbon dioxide, air, or methane. As used herein, the term “foamed” also refers to fluids such as commingled fluids. In some embodiments, a foamed fluid diversion system may be desirable to, among other things, reduce the amount of fluid that is required in a water sensitive subterranean formation, to provide fluid flow control in the formation, and/or to provide enhanced proppant suspension.

In examples of such embodiments, the gas may be present in the range of from about 5% to about 98% by volume of the fluid diversion system, and more preferably in the range of from about 20% to about 80% by volume of the fluid diversion system. The amount of gas to incorporate in the fluid may be affected by many factors including the viscosity of the fluid and the bottom hole pressures involved in a particular application. One of ordinary skill in the art, with the benefit of this disclosure, will recognize how much gas, if any, to incorporate into exemplary foamed fluid diversion systems.

Depending on the use of the fluid diversion system, in some embodiments, other additives may optionally be included in the exemplary fluid diversion systems of the present invention. Examples of such additives may include, but are not limited to, salts, pH control additives, surfactants, breakers, biocides, cross linkers, additional fluid loss control agents, stabilizers, chelating agents, scale inhibitors, gases, mutual solvents, particulates, corrosion inhibitors, oxidizers, reducers, and any combination thereof. A person of ordinary skill in the art, with the benefit of this disclosure, will recognize when such optional additives should be included in a fluid diversion system according to an exemplary embodiment of the present invention, as well as the appropriate amounts of those additives to include.

The viscosifying agent in exemplary fluid diversion systems of the present invention are in an amount sufficient to provide the desired viscosity for a particular use. In some embodiments, the viscosifying agents may be present in an amount in the range of from about 0.01% to about 10% by weight of the fluid diversion system. In other embodiments, the viscosifying agents may be cellulose derivatives present in an amount in the range of from about 0.1% to about 1% by weight of the fluid diversion system. In other embodiments, the viscosifying agents may be starches present in the range of from about 3% to 5% by weight of the fluid diversion system. In other embodiments, the viscosifying agents may be polysaccharides present from about 0.1% to 3% by weight of the fluid diversion system. In some embodiments, the viscosifying agent may be a mixture of a polysaccharide and a starch (as used herein, the term “starch” refers to a polysaccharide gum). Other components may be included as well, which will be known to those skilled in the art with the benefit of this disclosure.

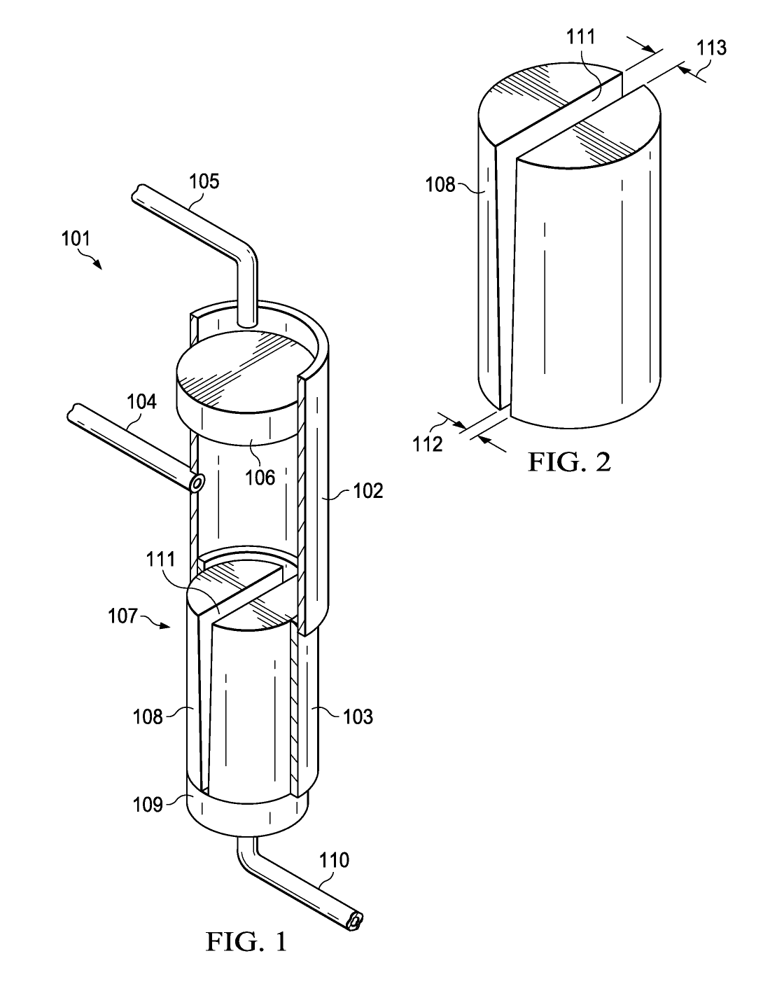

FIG. 1 is a schematic representation of a high pressure/high temperature test apparatus that was used in testing and demonstrating the effectiveness of alternative exemplary embodiments of a fluid diversion system. As illustrated in FIG. 1, a high temperature/high pressure test apparatus 101 was designed to include an upper chamber 102 and a lower chamber 103. A fluid diversion system reservoir (not shown) is connected to and in fluid communication with the upper chamber 102. The fluid diversion system is introduced into the upper chamber 102 through the fluid diversion system inlet 104. A nitrogen reservoir (not shown) is connected to and in fluid communication with the upper chamber 102. Nitrogen gas is introduced into the upper chamber 102 through the nitrogen inlet 105. A displacement piston 106 is located within the upper chamber 102. The lower chamber 103 is sealingly engaged to the upper chamber 102. Housed inside the lower chamber 103 is the frac slot holder 107, in which a variable frac slot 108 is positioned and held in place during the duration of the test. The variable frac slot 108 for this test fixture 101 measured approximately 12 inches in length and approximately 1 inch in diameter, and consists of two half-circular portions with an adjustable gap 111 between them. The top width and the bottom width of the adjustable gap can be varied. Located at the lower end of the lower chamber 103 is the collecting manifold 109, which seals off the lower end of the lower chamber 103. An effluent output 110 is located in the lower portion of the collecting manifold 109.

As illustrated in FIG. 2, interchangeable gaps 111 can be introduced into variable frac slot 108 to represent and simulate a subterranean fracture within a porous medium. Each alternative gap 111 had a smaller, variable-sized width 112 at the bottom than the width 113 at the top. The gap 111 used in each of the tests had a bottom width 112 that measured 0.05 inches. The corresponding top width 113 of gap 111 measured 0.1 inches.

In conducting the test, a fluid diversion system was introduced into the upper chamber 102 through the fluid diversion system inlet 104. Nitrogen gas was then introduced into the top portion of the upper chamber 102 and kept separated from the fluid diversion system by the displacement piston 106. Nitrogen was then forced into the upper chamber 102 to increase the pressure in the upper chamber 102 and drive the displacement piston 106 in a downward direction to hydraulically force the fluid diversion system into the frac slot 108, which was held within the frac slot holder 107 that is positioned within lower chamber 103.

The entire test proceeded at room temperature. The frac slot 108 was placed into a frac slot holder 107 with the upper chamber 102 forming a 1,000 ml fluid nitrogen piston drive accumulator located at the entrance of the frac slot 108 and collecting manifold 109 located downstream and at the bottom of the frac slot 108. After mounting the frac slot 108, a different formulation of fluid diversion system was placed in the nitrogen piston drive accumulator and nitrogen was introduced to the top of the displacement piston 106. By driving the displacement piston downward 106, the applied pressure was increased incrementally and the effluent that passed through frac slot 108 was measured over time for each pressure until no increase in effluent volume was observed. The effluent volume versus time at each pressure was recorded.

The following tests utilized various mixtures of exemplary fluid diversion systems of the present invention. These examples are not limitive of the present invention, but are provided only to illustrate efficacy of specific exemplary fluids.

These examples demonstrate the degradation characteristics of a fluid diversion system comprised of a cross-linked polymer gel and substantially insoluble, degradable bridging particulates. In conducting the tests, 400 cc of each selected fluid diversion system formulation was placed into the High pressure/High Temperature test cell 101 for injection into the variable frac slot 108. In each of the three tests, the variable frac slot was 0.1 inches wide at the top and 0.05 inches wide on the bottom. The formulations were also heated to 150, 175, and 200° F. The pH and fluid viscosity of the formulations were measured over a 7-day period. The test results (Table 1 through Table 3) indicate that the degradation of the substantially insoluble, degradable bridging particulates and the reduction in fluid viscosity depended upon the time, temperature, and concentrations of the components used in the fluid diversion system. The performances of all formulations tested are outlined in the tables below.

TABLE 1
Test-1
Differential Pressure Evaluations of Fluid Containing
1.0 PPG Solid HEC Material and 1.0 PPG PLA Material & 0.5 gal
Cross-linked HEC

| | Cross- | | | | Effluent | | |
|---|---|---|---|---|---|---|---|
| | linked | | Total | | | | Tot. |
| | HEC | Water | Volume | Differential | | | Vol. |
| Fluid formulation | Volume | Volume | Injected | Pressure | Time | Vol. | Injected |
| # 1 | (cc) | (cc) | (cc) | (psi) | (min.) | (cc) | (%) |
| Dry HEC 1.0 lb./gal | 200 | 200 | 400 | 250 | 1 | 0 | 0 |
| PLA 1.0 lb./gal | | | | 500 | 2 | 0 | 0 |
| Cross-linked HEC 0.5 gal | | | | 750 | 3 | 0 | 0 |
| Tap water 0.5 gal | | | | 850 | 4 | 0 | 0 |
| | | | | 1000 | 5 | 90 | 22.5 |
| | | | | 1000 | 60 | 90 | 22.5 |
| | | | | 1000 | 240 | 145 | 36.3 |

TABLE 2
Test - 1
Biodegradation of Fluid Containing 1.0 PPG
Solid HEC Material and 1.0 PPG PLA Material
& 0.5 gal Cross-linked HEC Over Time

| Time | Viscosity | Viscosity | Viscosity |
|---|---|---|---|
| Hr. | (cP) at 150° F. | (cP) at 175° F. | (cP) at 200° F. |
| 0 | >300 | >300 | >300 |
| 24 | >300 | >300 | 15 |
| 48 | >300 | >300 | 6 |
| 72 | >300 | >300 | 6 |
| 120 | >300 | >300 | 6 |
| 144 | >300 | >300 | 6 |
| 168 | >300 | >300 | 6 |

In Test 1, the fluid diversion system formulation number 1 that was tested comprised one pound per gallon (1.0 lb./gal) of dry, powdered hydroxyethyl cellulose (HEC), one pound per gallon (1.0 lb./gal) of polylactic acid (PLA), one half gallon (0.5 gal) of Cross-linked HEC (polymer gel) and one half gallon (0.5 gal) of water. The source of the water used was tap water. The volume of Cross-linked HEC was 200 cc and the volume of water was 200 cc, for a total volume of 400 cc of fluid diversion system formulation 1. The 400 cc of fluid diversion system formulation 1 was placed into the upper chamber 102 of the high pressure/high temperature test apparatus 101.

As outlined above, the fluid diversion system was forced into the simulated fracture, the frac slot 108 having an upper width of 0.10 and a lower width of 0.05 inches, by using nitrogen gas under pressure to move the displacement piston 106 in a downward direction and to maintain the differential pressures listed in Table 1 for the duration of time (in minutes) indicated. The volume of effluent that exited frac slot 108 was measured.

The results of the test as set forth in Table 1 and Table 2 of Test 1 show that the fluid diversion system formulation number 1 effectively plugged the simulated fracture or gap 111 within the variable frac slot 108 at high pressure and high temperature. The PLA created or formed an initial bridge across the gap 111 within the variable frac slot 108, the particulate solid dry HEC formed a bridge on the PLA, and the Cross-linked HEC in combination with the dry HEC and PLA sealed up the gap 111.

As outlined in Table 1 of Test 1, no measurable volume of effluent exiting the variable frac slot 108 was recorded for the first 4 minutes of the four hour long test, at which time the differential pressure across the variable frac slot 108 was increased from zero pounds per square inch (psi) to 850 psi. The differential pressure across variable frac slot 108 was increased from zero psi to 250 psi at 1 minute, the differential pressure was increased to 500 psi at 2 minutes, the differential pressure was increased to 750 psi at 3 minutes, and the differential pressure was increased to 850 psi at 4 minutes. When the differential pressure was increased to one thousand pounds per square inch (1,000 psi) and 5 minutes had passed from the time that a differential pressure was initially induced, 90 cc of effluent exited the variable frac slot 108, representing 22.5% of the total volume of fluid diversion system that was placed into the upper chamber 102 of the high pressure/high temperature test apparatus 101. Thereafter, the differential pressure was held at 1,000 psi for another 55 minutes (for a total of 60 minutes or 1 hour after a differential pressure was initially induced) and no additional volume of effluent exited the variable frac slot 108. Then, the differential pressure was held at 1,000 psi for another 3 hours, for a total of 4 hours from the time a differential pressure was initially induced, and another 55 cc of effluent volume was measured. Accordingly, for the entire 4-hour duration of the test, a total amount of 145 cc exited the variable frac slot 108, representing 36% of the total 400 cc of fluid placed into the upper chamber 102 of the high pressure/high temperature test apparatus 101.

As outlined in Table 2 of Test 1, when the temperature of the fluid diversion system formulation number 1 was held at 150° F. for the duration of the test, namely 168 hours (or 7 full days), the viscosity did not change at all and remained at greater than 300 cP (centipoise). The same results were obtained when the temperature of the fluid diversion system formulation number 1 was held at 175° F., with the viscosity remaining at greater than 300 cP for 168 hours.

When the temperature of the fluid diversion system formulation number 1 was held at 200° F., the viscosity dropped drastically to just 15 cP within the first 24 hours and then down to just 6 cP at 48 hours. The viscosity then remained at 6 cP for the remainder of the test.

TABLE 3
TEST-2
Differential Pressure Evaluations of Fluid Contains
0.5 PPG Solid HEC Material and 0.5 PPG PLA Material& 0.25 gal
Cross-linked HEC

| | Cross- | | | | | | |
|---|---|---|---|---|---|---|---|
| | linked | | Total | | Effluent | | |
| | HEC | Water | Volume | Differential | | | Tot. Vol. |
| | Volume | Vol. | Injected | Pressure | Time | Vol. | Injected |
| Fluid formulation 2 | (cc) | (cc) | (cc) | (psi) | (min.) | (cc) | (%) |
| Dry HEC 0.5 lb./gal | 100 | 300 | 400 | 250 | 1 | 50 | 12.5 |
| PLA 0.5 lb./gal | | | | 500 | 2 | 70 | 17.5 |
| Cross-linked HEC 0.25 gal | | | | 750 | 3 | 80 | 20.0 |
| Tap water 0.75 gal | | | | 850 | 4 | 90 | 22.5 |
| | | | | 1000 | 5 | 100 | 25.0 |
| | | | | 1000 | 60 | 140 | 35.0 |
| | | | | 1000 | 240 | 150 | 37.5 |

TABLE 4
Test - 2
Biodegradations of Fluid Contains 0.5 PPG
Solid HEC Material and 0.5 PLA Material
& 0.25 gal Cross-linked HEC Over Time

| Time | Viscosity | Viscosity | Viscosity |
|---|---|---|---|
| Hr. | (cP) at 150° F. | (cP) at 175° F. | (cP) at 200° F. |
| 0 | >300 | >300 | >300 |
| 24 | >300 | >300 | 9 |
| 48 | >300 | >300 | 6 |
| 72 | >300 | 223 | 6 |
| 120 | 300 | 75 | 6 |
| 144 | 129 | 55 | 6 |
| 168 | 64 | 10 | 6 |

In Test 2, the fluid diversion system formulation number 2 that was tested comprised one half pound per gallon (0.5 lb./gal) of dry, powdered hydroxyethyl cellulose (HEC), one half pound per gallon (0.5 lb./gal) of polylactic acid (PLA), one quarter gallon (0.25 gal) of Cross-linked HEC (polymer gel) and three fourths of a gallon (0.75 gal) of water. The fluid diversion system formulation number 2 used in test 2 had one half the concentration of particulate solid HEC, PLA and Cross-linked HEC than the fluid diversion system formulation number 1 used in test 1. The source of the water used was tap water. The volume of Cross-linked HEC was 100 cc and the volume of water was 300 cc, for a total volume of 400 cc of fluid diversion system formulation number 2 placed into the upper chamber 102 of the high pressure/high temperature test apparatus 101.

As outlined above, the fluid diversion system formulation number 2 was forced into the simulated fracture, the frac slot 108, by using nitrogen gas under pressure to move the displacement piston 106 in a downward direction and to maintain the differential pressures listed in Table 3 for the duration of time (in minutes) indicated. The volume of effluent that exited frac slot 108 was measured.

The results of the test as set forth in Table 3 and Table 4 of Test 2 show that the fluid diversion system formulation number 2 effectively plugged the simulated fracture or gap 111 within the variable frac slot 108 at high pressure and high temperature. The PLA created or formed an initial bridge across the gap 111 within the variable frac slot 108, the solid dry HEC formed a bridge on the PLA, and the Cross-linked HEC in combination with the dry HEC and PLA sealed up the gap 111.

As outlined in Table 3 of Test 2, the volume of effluent exiting the variable frac slot 108 was 100 cc for the first 5 minutes of the 4 hour long test, during which time the differential pressure across the variable frac slot 108 was increased from zero pounds per square inch (psi) to 1,000 psi. The differential pressure across variable frac slot 108 was increased from zero psi to 250 psi at 1 minute, the differential pressure was increased to 500 psi at 2 minutes, the differential pressure was increased to 750 psi at 3 minutes, and the differential pressure was increased to 850 psi at 4 minutes. When the differential pressure was increased to 1,000 psi and 5 minutes had passed from the time that a differential pressure was initially induced, 100 cc of effluent exiting the variable frac slot 108 was measured, representing 25% of the total volume of fluid diversion system formulation number 2 that was placed into the upper chamber 102 of the high pressure/high temperature test apparatus 101.

Thereafter, the differential pressure was held at 1,000 psi for another 55 minutes (for a total of 60 minutes or 1 hour after a differential pressure was initially induced) and 40 cc of additional volume of effluent exited the variable frac slot 108. Accordingly, a total of 140 cc of effluent exited the variable frac slot 108 during the 60 minutes (1 hour) of the four-hour test, representing 35% of the total 400 cc of fluid diversion system formulation number 2 placed into the upper chamber 102 of the high pressure/high temperature test apparatus 101. Then, the differential pressure was held at 1,000 psi for another 3 hours, for a total of 4 hours from the time a differential pressure was initially induced, and another 10 cc of effluent volume was measured. Accordingly, for the entire four-hour duration of the test, a total amount of 150 cc exited the variable frac slot 108, representing 37.5% of the 400 cc of fluid diversion system formulation number 2 placed into the upper chamber 102 of the high pressure/high temperature test apparatus 101.

As outlined in Table 4 of Test 2, when the temperature of the fluid diversion system formulation number 2 was held at 150° F., for the first 72 hours (3 days) of the test, the viscosity did not change at all and remained at greater than 300 cP. The viscosity dropped to 300 cP at 120 hours (5 days), and then to 129 cP at 144 hours (6 days), and to 64 cP at 168 hours (7 days).

When the temperature of the fluid diversion system formulation number 2 was held at 175° F., the viscosity dropped sooner than when the temperature was held at 150° F. When the temperature of the fluid diversion system formulation number 2 was held at 175° F., the viscosity remained at greater than 300 cP for 48 hours (2 days). Thereafter, with the temperature of the fluid diversion system formulation number 2 being held at 175° F., the viscosity dropped to 223 cP at 72 hours (3 days), to 75 cP at 120 hours (5 days), 55 cP at 144 hours (6 days), and 10 cP at 168 hours (7 days).

When the temperature of the fluid diversion system formulation number 2 was held at 200° F., the viscosity again dropped sooner than when the temperature was held at 175° F. When the temperature of the fluid diversion system formulation number 2 was held at 200° F., the viscosity dropped drastically to just 9 cP within the first 24 hours and then down to just 6 cP at 48 hours. The viscosity then remained at 6 cP for the remainder of the test.

TABLE 5
TEST-3
Differential Pressure Evaluations of Fluid Contains
0.25 PPG Solid HEC Material and 0.25 PPG PLA Material& 0.5 gal
Cross-linked HEC

| | Cross- | | | | Effluent | | |
|---|---|---|---|---|---|---|---|
| | linked | | Total | | | | Tot. |
| | HEC | Water | Volume | Differential | | | Vol. |
| | Volume | Volume | Injected | Pressure | Time | Vol. | Injected |
| Fluid formulation 3 | (cc) | (cc) | (cc) | (psi) | (min.) | (cc) | (%) |
| Dry HEC 0.25 lb./gal | 50 | 350 | 400 | 250 | 1 | 50 | 12.5 |
| PLA 0.25 lb./gal | | | | 500 | 2 | 70 | 17.5 |
| Cross-linked HEC 0.125 gal | | | | 750 | 3 | 90 | 225 |
| Tap water 0.875 gal | | | | 850 | 4 | 100 | 25.0 |
| | | | | 1000 | 5 | 120 | 30.0 |
| | | | | 1000 | 60 | 140 | 35.0 |
| | | | | 1000 | 240 | 175 | 43.75 |

TABLE 6
Test - 3
Biodegradations of Fluid Contains 0.25 PPG
Solid HEC Material and 0.25 PPG PLA Material
& 0.5 gal Cross-linked HEC Over Time

| Time | Viscosity | Viscosity | Viscosity |
|---|---|---|---|
| Hr. | (cP) at 150° F. | (cP) at 175° F. | (cP) at 200° F. |
| 0 | >300 | >300 | >300 |
| 24 | >300 | 198 | 6 |
| 48 | >300 | 90 | 6 |
| 72 | >300 | 64 | 6 |
| 120 | 295 | 33 | 6 |
| 144 | 195 | 33 | 6 |
| 168 | 39 | 23 | 6 |

In Test 3, the fluid diversion system formulation number 3 that was tested comprised one quarter pound per gallon (0.25 lb./gal) of dry, powdered hydroxyethyl cellulose (HEC), one quarter pound per gallon (0.25 lb./gal) of polylactic acid (PLA), one eighth gallon (0.125 gal) of Cross-linked HEC (polymer gel) and seven eighths of a gallon (0.875 gal) of water. The fluid diversion system formulation number 3 used in test 3 had one half the concentration of solid HEC, PLA and Cross-linked HEC than the fluid diversion system formulation number 2 used in test 2. The source of the water used was tap water. The volume of Cross-linked HEC was 100 cc and the volume of water was 300 cc, for a total volume of 400 cc of fluid diversion system formulation number 3 placed into the upper chamber 102 of the high pressure/high temperature test apparatus 101.

As outlined above, the fluid diversion system formulation number 3 was forced into the simulated fracture, the frac slot 108, by using nitrogen gas under pressure to move the displacement piston 106 in a downward direction and to maintain the differential pressures listed in Table 5 for the duration of time (in minutes) indicated. The volume of effluent that exited frac slot 108 was measured.

The results of the test as set forth in Table 5 and Table 6 of Test 3 show that the fluid diversion system formulation number 3 effectively plugged the simulated fracture or gap 111 within the variable frac slot 108 at high pressure and high temperature. The PLA created or formed an initial bridge across the gap 111 within the variable frac slot 108, the solid dry HEC formed a bridge on the PLA, and the Cross-linked HEC in combination with the dry HEC and PLA sealed up the gap 111.

As outlined in Table 5 of Test 3, the volume of effluent exiting the variable frac slot 108 was 120 cc for the first 5 minutes of the 4 hour long test, during which time the differential pressure across the variable frac slot 108 was increased from zero pounds per square inch (psi) to 1,000 psi. The differential pressure across variable frac slot 108 was increased from zero psi to 250 psi at 1 minute, the differential pressure was increased to 500 psi at 2 minutes, the differential pressure was increased to 750 psi at 3 minutes, and the differential pressure was increased to 850 psi at 4 minutes. When the differential pressure was increased to 1,000 psi and 5 minutes had passed from the time that a differential pressure was initially induced, 120 cc of effluent exiting the variable frac slot 108 was measured, representing 30% of the total volume of fluid diversion system formulation number 3 that was placed into the upper chamber 102 of the high pressure/high temperature test apparatus 101.

Thereafter, the differential pressure was held at 1,000 psi for another 55 minutes (for a total of 60 minutes or one hour after a differential pressure was initially induced) and 20 cc of additional volume of effluent exited the variable frac slot 108. Accordingly, a total of 140 cc of effluent exited the variable frac slot 108 during the first 60 minutes (one hour) of the four-hour test, representing 35% of the total 400 cc of fluid diversion system formulation number 3 placed into the upper chamber 102 of the high pressure/high temperature test apparatus 101. Then, the differential pressure was held at 1,000 psi for another 3 hours, for a total of 4 hours from the time a differential pressure was initially induced, and another 35 cc of effluent volume was measured. Accordingly, for the entire 4-hour duration of the test, a total amount of 175 cc exited the variable frac slot 108, representing 43.75% of the total 400 cc of fluid diversion system formulation number 3 placed into the upper chamber 102 of the high pressure/high temperature test apparatus 101.

As outlined in Table 6 of Test 3, when the temperature of the fluid diversion system formulation number 3 was held at 150° F., for the first 72 hours (3 days) of the test, the viscosity did not change at all and remained at greater than 300 cP. The viscosity dropped to 295 cP at 120 hours (5 days), and then to 195 cP at 144 hours (6 days), and to 39 cP at 168 hours (7 days).

When the temperature of the fluid diversion system formulation number 3 was held at 175° F., Table 6 of Test 3 shows that the viscosity dropped sooner than when the temperature was held at 150° F. When the temperature of the fluid diversion system formulation number 3 was held at 175° F., the viscosity dropped from greater than 300 cP to 198 cP after 24 hours (1 day). Thereafter, with the temperature of the fluid diversion system formulation number 3 being held at 175° F., the viscosity dropped to 90 cP at 48 hours (2 days), 64 cP at 72 hours (3 days), and to 33 cP at 120 hours (5 days). The viscosity remained at 33 cP at 144 hours (6 days), but then dropped to 23 cP at 168 hours (7 days).

When the temperature of the fluid diversion system formulation number 3 was held at 200° F., the viscosity again dropped to 6 cP within the first 24 hours (1 day) and then remained at 6 cP for the remainder of the test (through 168 hours).

Collectively, Tests 1, 2, and 3 demonstrate that each of the three alternative exemplary fluid diversion systems of the present invention that were tested effectively plugged the simulated fracture or gap 111 within the variable frac slot 108 at high pressure and high temperature. Also, the tests show that, in the field, an operator can select various concentrations of the constituents of the fluid diversion system (e.g., dry HEC, PLA, Cross-linked HEC, and water) to use depending on the downhole environment to be encountered. For example, if the bottom hole temperature is between approximately 150° F. and approximately 175° F., then the fluid diversion system selected will degrade at a much lower rate than if the downhole temperature were 200° F. or higher. In turn, as the anticipated duration of time increases that a fluid diversion system will have to remain downhole and still perform, the operator can select relatively higher concentrations of the constituents (e.g., dry HEC, PLA, Cross-linked HEC, and water) to ensure that the viscosity of the fluid diversion system remains at an acceptable level and the fluid does not degrade too early.

An operator may desire to re-fracture the wellbore after the production rate from the formation has declined. The operator can re-fracture the wellbore using an exemplary embodiment of a fluid diversion system of the present invention.

The formulation of the exemplary fluid diversion system may be selected based on known downhole parameters and the anticipated duration of the treatment operations, as outlined herein. The exemplary fluid diversion system can be mixed prior to shipping or alternatively mixed at the well site. In an exemplary embodiment, a high-viscosity Cross-linked HEC is mixed with fresh water prior to shipment of the fluid diversion system to the well site. Solid HEC particles and solid PLA particles can also be pre-mixed with the Cross-linked HEC and water prior to shipment. Alternatively, the solid HEC particles and solid PLA particles can be added separately to the blender top as the carrier fluid (high-viscosity Cross-linked HEC and water) is pumped into the wellbore. As outlined above, the sizes of the particulates of a substantially insoluble, degradable bridging composition are selected based on the specific downhole conditions and can range, for example, from about U.S. mesh 6 (3,350 microns) to U.S. mesh of less than 200 (40 microns).

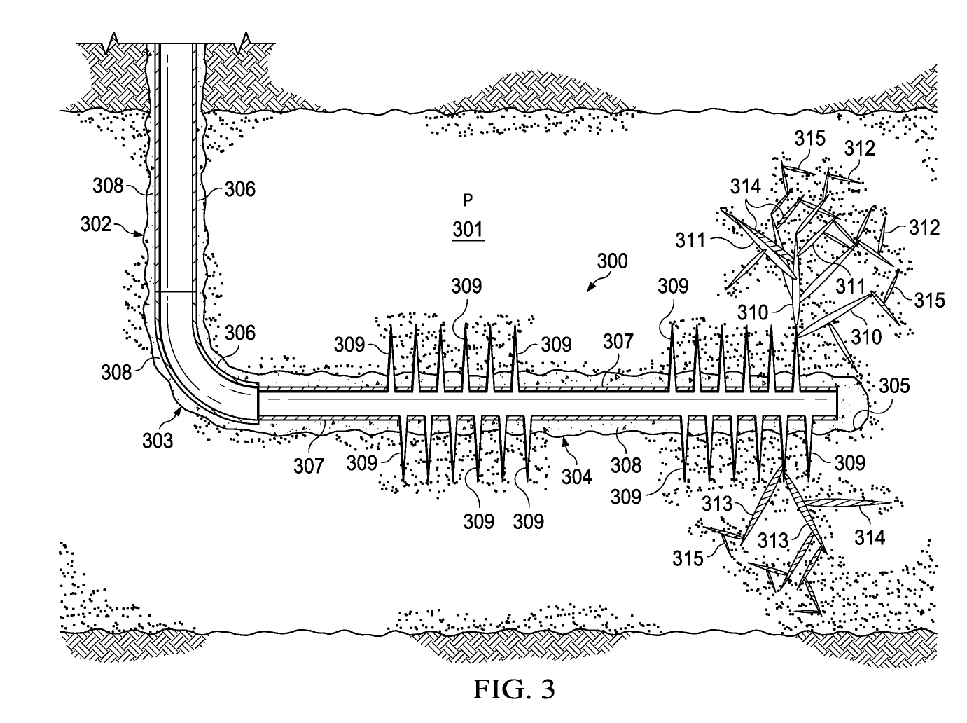

FIG. 3 illustrates a portion of a subterranean wellbore 300 that was drilled through a production zone (P), cased or lined with a liner 307, and perforated, and depicts the use of an exemplary embodiment of a fluid diversion system for re-fracturing the production zone (P) that was previously fractured. The wellbore 300 has been drilled into a formation 301. A vertical portion 302 of the wellbore 300 is shown, which leads to the surface (not shown) of the earth. The vertical portion 302 is connected to and in fluid communication with the heel 303 or bent portion of the wellbore 300, which in turn is connected to and in fluid communication with the horizontal portion 304 of the wellbore 300, which has been drilled into the production zone (P) of the formation 301. The wellbore 300 terminates at the toe 305.

As shown in FIG. 3, the entire wellbore has been “cased,” meaning that the wellbore has been lined throughout, including through the production zone (P) of the formation 301, with a metal tubular known as casing or a liner 306. As shown, casing 306, a metal tubular conduit, has been run and cemented into place in the vertical portion 302 and the heel 303. Cement 308 was pumped downhole and circulated into position within the annular space formed between the casing and the wellbore 300 to cement the casing in place and to prevent the uncontrolled migration of hydrocarbons from the production zone (P) to the surface. A liner 307, also typically a metal tubular conduit and also referred to as casing, has been run and placed into the horizontal portion 304, extending through the production zone (P). The liner 307 has been cemented into place within the horizontal portion 304 of the wellbore 300 using cement 308. The liner 307 has been perforated, as depicted by the perforations 309, and the formation around the liner has already been fractured.

Initial near-perforation fractures 310 are shown extending from one of the plurality of perforations 309. Initial near-wellbore fractures 311, also referred to as secondary fractures, are shown extending from the initial near-perforation fractures 310. Initial far-field fractures 312, those fractures that are beyond the initial near-wellbore fractures or secondary fractures, are shown extending from initial near-wellbore fractures 311.

In an exemplary embodiment of the present invention involving improved methods for cased wellbore re-fracturing operations, the formation pressure is often depleted and a recharge of the formation is required to ensure that the formation pressure is greater than the hydrostatic pressure of fluids within the wellbore 300, including the fluid treatment. In conducting an exemplary embodiment of the improved methods for re-fracturing operations, the injection rate of the water and fluid diversion system is preferably twenty barrels per minute (20 BPM). Water is injected into the wellbore 300 until the desired formation injection pressure is achieved, which is determined by conventional methods of calculating the downhole formation pressure based on known parameters such as the pressure measured at the surface, the depth of production zone (P) within the formation 301, and the densities of the fluids within the wellbore 300.

After the desired formation injection pressure is achieved, the perforated portion of the wellbore 300 may then be plugged using a pill of an exemplary fluid diversion system. The volume of the pill of exemplary fluid diversion system to be used depends upon the number and sizes of the perforations 309 that exist in the liner 307 that was cemented into place within the horizontal portion 304 of the wellbore 300. For example, the pill of fluid diversion system may have a volume ranging between twenty-five hundred (2,500) and five thousand (5,000) gallons. The pill of fluid diversion system is pumped into the wellbore, which displaces the previously injected water into the formation 301. The operator monitors the surface treating pressure (STP) as the pill of fluid diversion system is pumped downhole. As the fluid diversion system reaches the perforations 309 and the pre-existing initial near-perforation fractures 310, the initial near-wellbore fractures 311, and initial far-field fractures 312, the surface treating pressure (STP) will increase. The increase in STP is due to the substantially insoluble, degradable bridging particulates bridging across the initial near-perforation fractures 310, the initial near-wellbore fractures 311, and the initial far-field fractures 312, followed by the solid HEC and the high viscosity Cross-linked HEC, which together seal off the initial near-perforation fractures 310, the initial near-wellbore fractures 311, and the initial far-field fractures 312. As the operator continues to pump fluids at the surface and the pressure further increases within the wellbore 300, a new fracture network will be initiated in the formation 301. For instance, new near-perforation fractures 313 may be initiated that extend from the perforations. Furthermore, new near-wellbore fractures 314 may be initiated that extend from the initial near-perforation fractures 310, the initial near-wellbore fractures 311, and the new near-perforation fractures 313. Finally, new far-field fractures 315 may be initiated and extend from the initial near-wellbore fractures 311, the new near-wellbore fractures 314, and the initial far-field fractures 312. In performing an exemplary embodiment of re-fracturing operations, an operator may select the size distributions of the substantially insoluble, degradable bridging particulates (e.g. HEC and PLA) to optimally achieve new far-field fractures 315, new near-wellbore fractures 314, and new near-perforation fractures 313. For creating new far-field fractures 315, the operator should lower the pump rate during the pumping of the fluid treatment after the fluid treatment has been pumped into the formation and use smaller sizes of substantially insoluble, degradable bridging particulates for bridging across the existing far-field fractures 312 (based on the estimated width of the existing, initial far-field fractures 312) and relatively larger-sized substantially insoluble, degradable bridging particulates for the initial near-wellbore fractures 311 and the initial far-field fractures 312.

Once a new fracture network is initiated, the operator proceeds with the frac stage of the operation by pumping frac fluids containing proppant, at designed frac rates, into the new fractures 313, 314, and 315 of the new fracture network within the formation 301. This proppant stage is followed with pumping a volume of displacement fluid, for example, a five thousand (5,000) to ten thousand (10,000) gallon spacer of displacement fluid into the new fractures 313, 314, and 315. After the displacement fluid has been pumped into the new fractures 313, 314, and 315, another pill of fluid diversion system is pumped into the new fractures 313, 314, and 315 of the new fracture network so that the operator may then repeat the re-fracturing process. Furthermore, an exemplary embodiment of a fluid diversion system may be used for re-fracturing an “open” wellbore, or portion thereof, that was previously fractured. The term “open” means that at least a portion of the wellbore that has been drilled into the production zone of the formation has not been lined with casing or a liner. Operators may elect or may be forced to complete a well without a casing or a liner being placed into the portion of the wellbore that is drilled through a production zone. In some instances, it is not economically feasible to deploy a liner into every lateral wellbore that extends from a primary wellbore. In other instances, downhole conditions will actually prevent the operator from being able to physically deploy or run a liner into at least a portion of the horizontal wellbore. For example, the horizontal section of a wellbore may be of such length that the force that can be generated from the drilling rig for running the liner and forcing the liner into the horizontal portion cannot overcome the frictional forces encountered from running the liner into the wellbore.

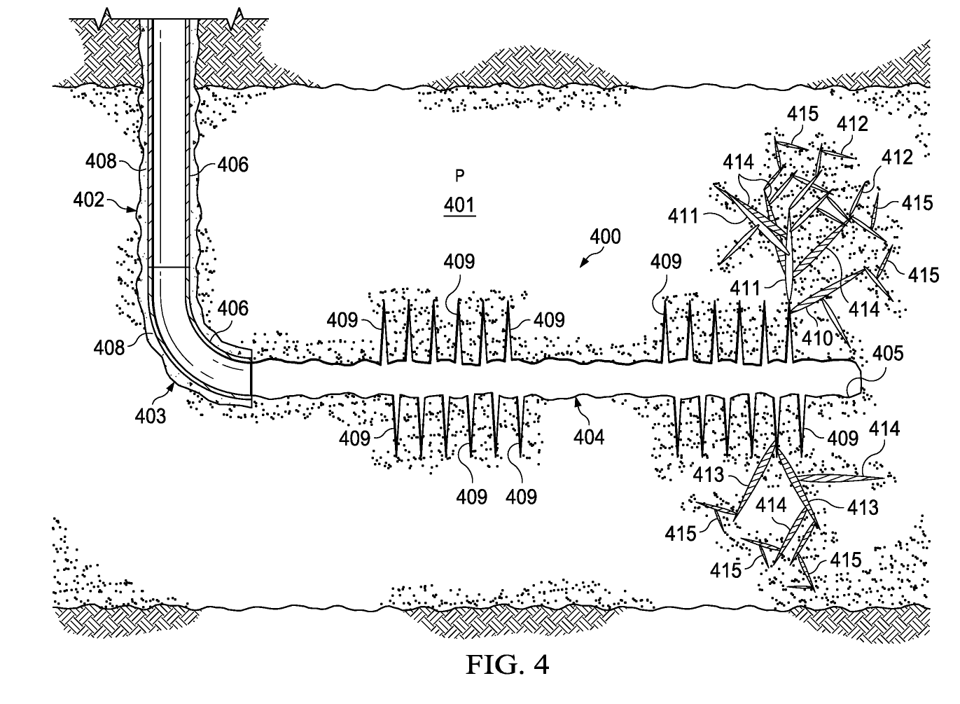

FIG. 4 depicts a portion of a subterranean wellbore 400 having a horizontal portion 404 that was drilled through a production zone (P) and completed as an open wellbore, and depicts the use of an exemplary embodiment of a fluid diversion system for re-fracturing the production zone (P) that was previously fractured. The wellbore 400 has been drilled into a formation 401. A vertical portion 402 of the wellbore 400 is shown, which leads to the surface (not shown) of the earth. The vertical portion 402 is connected to and in fluid communication with the heel 403 or bent portion of the wellbore 400, which in turn is connected to and in fluid communication with the horizontal portion 404 of the wellbore 400. The wellbore 400 terminates at the toe 405.

As shown in FIG. 4, only the vertical portion 402 and the heel 403 of the wellbore have been “cased,” meaning that these portions of the wellbore have been lined with a metal tubular known as casing or a liner. As shown, casing 406, a metal tubular conduit, has been run and cemented into place in the vertical portion 402 and the heel 403. Cement 408 was pumped downhole and circulated into position within the annular space formed between the casing 406 and the wellbore 400 to cement the casing 406 in place and to prevent the uncontrolled migration of hydrocarbons from the production zone (P) to the surface.

The horizontal portion 404 of the wellbore, which was drilled through the production zone, is “open,” meaning that no liner or casing was deployed into the horizontal portion 404 of the wellbore 400. The operator may elect to perforate the formation along the horizontal portion of the wellbore to create perforations 409.

Initial near perforation fractures 410 and near-wellbore fractures 411 are shown extending from the horizontal portion 404 of the wellbore 400. Initial far-field fractures 412 are shown extending from initial near-wellbore perforations 411.

In an exemplary embodiment of the present invention involving improved methods for open wellbore re-fracturing operations, the formation pressure is often depleted and a recharge of the formation is required to ensure that the formation pressure is greater than the hydrostatic pressure of fluids within the wellbore 400, including the fluid treatment. In conducting an exemplary embodiment of the improved methods for open wellbore re-fracturing operations, the injection rate of the water and fluid diversion system is preferably twenty barrels per minute (20 BPM). Water is injected into the wellbore 400 until the desired formation injection pressure is achieved, which is determined by conventional methods of calculating the downhole formation pressure based on known parameters such as the pressure measured at the surface, the depth of the formation 401, and the densities of the fluids within the wellbore.

After the desired formation injection pressure is achieved, the existing fractures within the open horizontal portion 404 of the wellbore 400 may then be plugged using a pill of an exemplary fluid diversion system or fluid diversion system. The volume of the pill of exemplary fluid diversion system to be used depends upon the length of the horizontal portion 404 of the wellbore 400 to be re-fractured. For example, the pill of fluid diversion system may have a volume ranging between twenty-five hundred (2,500) and five thousand (5,000) gallons. The pill of fluid diversion system is pumped into the wellbore, which displaces the previously injected water into the formation 401. The operator monitors the surface treating pressure (STP) as the pill of fluid diversion system is pumped downhole. As the fluid diversion system reaches the initial near-perforation fractures 410, initial near-wellbore fractures 411 and initial far-field fractures 412, the surface treating pressure (STP) will increase. The increase in STP is due to the substantially insoluble, degradable bridging particulates, such as PLA, HEC, CMC, Guar gum and HPS, bridging across the initial near-wellbore fractures 411 followed by the high viscosity Cross-linked HEC, which together seal off the initial near-wellbore fractures 411. As the operator continues to pump fluids at the surface and the pressure further increases within the wellbore 400, a new fracture network will be initiated in the production zone (P) of the formation 401. For instance, new near perforation fractures 413 and new near-wellbore fractures 414 may be initiated that extend from the horizontal portion 404 of the wellbore 400. Furthermore, new far-field fractures 415 may be initiated and extend from the initial near-wellbore fractures 411, the new near-wellbore fractures 414, and the initial far-field fractures 412. In performing an exemplary embodiment of open wellbore re-fracturing operations, an operator may select the size distributions of the substantially insoluble, degradable bridging particulates (e.g., PLA, HEC, CMC, Guar gum, and HPS) to optimally achieve new far-field fractures 415 and new near-wellbore fractures 414. For creating new far-field fractures 415, the operator should lower the pump rate during the pumping of the fluid treatment after the fluid treatment has been pumped into the formation and use smaller sizes of substantially insoluble, degradable bridging particulates for bridging across the existing far-field fractures 412 (based on the estimated width of the existing, initial far-field fractures 412) and relatively larger-sized substantially insoluble, degradable bridging particulates for the initial near-wellbore fractures 411 and the initial far-field fractures 412.

Once a new fracture network is initiated, the operator proceeds with the frac stage of the operation by pumping frac fluids containing proppant (i.e., sand or bead material, such as plastic or ceramic beads, of a predetermined size), at designed frac rates, into the new near-wellbore fractures 414 and the new far-field fractures 415 of the new fracture network. This proppant stage is followed with pumping a volume of displacement fluid, for example, a five thousand (5,000) to ten thousand (10,000) gallon spacer of displacement fluid into the new near-wellbore fractures 414 and the new far-field fractures 415. After the displacement fluid has been pumped into the new near-wellbore fractures 414 and the new far-field fractures 415, another pill of fluid diversion system is pumped into the new near-wellbore fractures 414 and the new far-field fractures 415 of the new fracture network so that the operator may then repeat the process.

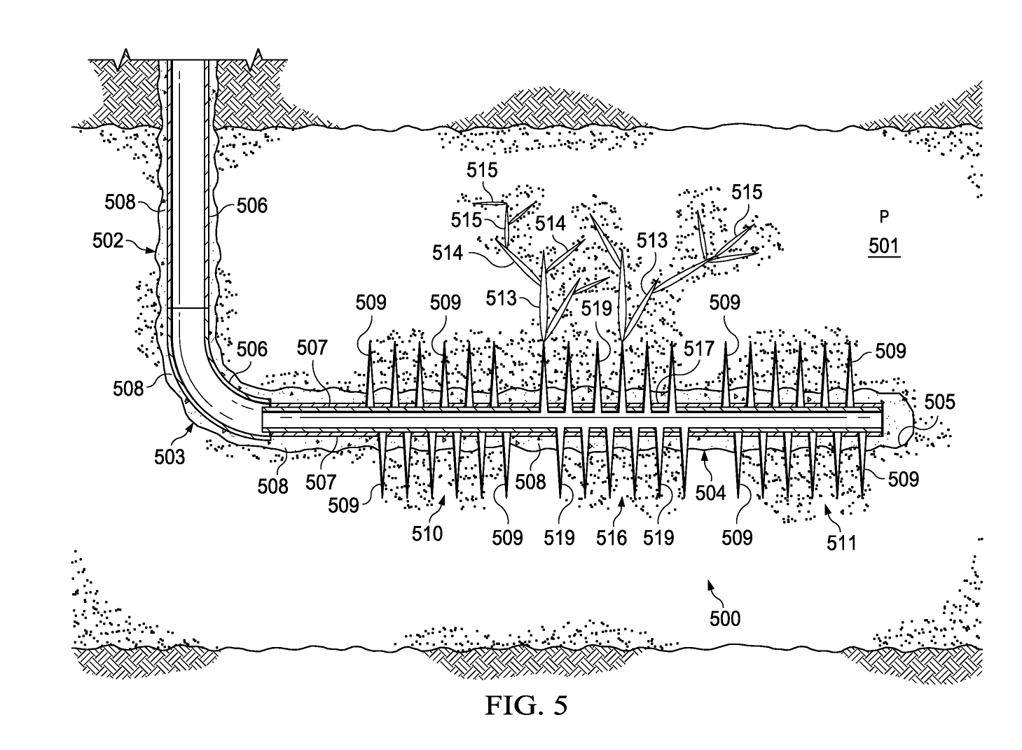

FIG. 5 illustrates a portion of a subterranean wellbore 500, including a horizontal portion 504 that was drilled through a production zone, cased, and perforated, and depicts the use of an exemplary embodiment of a fluid diversion system for use in perforating a new section 517 of the liner 507 in the cased horizontal portion 504 of the wellbore 500 and fracturing a new region 516 of the production zone (P) behind the new perforations 519. The wellbore 500 has been drilled into a formation 501. A vertical portion 502 of the wellbore 500 is shown, which leads to the surface (not shown) of the earth. The vertical portion 502 is connected to and in fluid communication with the heel 503 or bent portion of the wellbore 500, which in turn is connected to and in fluid communication with the horizontal portion 504 of the wellbore 500, which has been drilled into the production zone (P) of the formation 501, cased, and perforated. The wellbore 500 terminates at the toe 505.

As shown, casing 506, a metal tubular conduit, has been run and cemented into place in the vertical portion 502 and the heel 503. The cement 508 is positioned in the annular space formed between the casing and the wellbore 500 to cement the casing in place and to prevent the uncontrolled migration of hydrocarbons from the production zone(s) to the surface.

A liner 507, also typically a metal tubular conduit and also referred to as casing, has been run and placed into the horizontal portion 503 and cemented into place within the horizontal portion 504 of the wellbore 500 using cement 508. The liner 507 has been initially perforated in two zones 510 and 511, as depicted by and corresponding with the two sets of perforations 509.

In an exemplary embodiment of the present invention involving improved methods for perforating and fracturing a new section 504 of a cased wellbore 500, the formation pressure is often depleted and a recharge of the formation 501 is required to ensure that the formation pressure is greater than the hydrostatic pressure of fluids within the wellbore 500, including the fluid treatment. In conducting an exemplary embodiment of the improved methods for cased wellbore re-fracturing operations, the injection rate of the water and fluid diversion system is preferably twenty barrels per minute (20 BPM). Water is injected into the wellbore 500 until the desired formation injection pressure is achieved, which is determined by conventional methods of calculating the downhole formation pressure based on known parameters such as the pressure measured at the surface, the depth of the formation 501, and the densities of the fluids within the wellbore.

After the desired formation injection pressure is achieved, the perforated portion of the wellbore 500 may then be plugged using a pill of an exemplary fluid diversion system or fluid diversion system. The volume of the pill of exemplary fluid diversion system to be used depends upon the length of the horizontal portion 504 of the wellbore 500 to be re-fractured. For example, the pill of fluid diversion system may have a volume ranging between twenty-five hundred (2,500) and five thousand (5,000) gallons. The pill of fluid diversion system is pumped into the wellbore, which displaces the previously injected water into the formation 501. The operator monitors the surface treating pressure (STP) as the pill of fluid diversion system is pumped downhole. As the fluid diversion system passes through the perforations 509 and reaches the initial near-wellbore fractures (not shown) and initial far-field fractures (not shown) of zones 510 and 511, the surface treating pressure (STP) will increase. The increase in STP is due to the substantially insoluble, degradable bridging particulates bridging across the initial near-wellbore fractures (not shown) in zones 510 and 511 followed by the solid HEC and the high viscosity Cross-linked HEC, which together seal off the initial near-wellbore fractures (not shown) in zones 510 and 511 and the perforations 509.

Once the perforations 509 in the liner 507 have been sealed off, perforating guns (not shown) are then tripped into the wellbore 500 by conventional means (e.g., coiled tubing, jointed tubing, wireline, etc.) and positioned within the horizontal portion 504 proximate the location where new perforations 519 are to be made in the liner 507 and the new region 516 of the production zone (P) to be fractured. After the perforating guns are fired to create the new perforations 519 in the liner 507, the perforating guns are tripped out and removed from the wellbore, and then the fracturing operations for new zone 516 are commenced.

As the operator continues to pump fluids at the surface and the pressure further increases within the wellbore 500, a new fracture network will be initiated in the new region 516 of the production zone (P). For instance, new near-perforation fractures 513 may be initiated that extend from the perforations 519. Furthermore, new near-wellbore fractures 514 may be initiated that extend from the new near-perforation fractures 513. Finally, new far-field fractures 515 may be initiated and extend from the new near-wellbore fractures 514.

In performing an exemplary embodiment of a method of using a fluid diversion system for perforating a new section 517 of the cased horizontal portion 505 of the wellbore 500 and fracturing a new region 516 of the production zone (P) of re-fracturing operations, an operator may select the size distributions of the substantially insoluble, degradable bridging particulates (e.g. PLA, HEC, CMC, Guar gum, and HPS) to optimally seal off the existing perforations 509 while achieving a successful frac operation that creates new near-perforation fractures 513, new near-wellbore fractures 514, and new far-field fractures 515.

Once a new fracture network is initiated in the new region 516 of the production zone (P), the operator proceeds with the frac stage of the operation by pumping frac fluids containing proppant, at designed frac rates, into the new fractures 513, 514, and 515 of the new fracture network. This proppant stage is followed with pumping a volume of displacement fluid, for example, a five thousand (5,000) to ten thousand (10,000) gallon spacer of displacement fluid into the new fractures 513, 514, and 515. After the displacement fluid has been pumped into the new fractures 513, 514, and 515, another pill of fluid diversion system may be pumped into the new fractures 513, 514, and 515 of the new fracture network so that the operator may then repeat the process of perforating yet another new section of the cased horizontal portion 504 of the wellbore 500 and fracturing a new region of the production zone (P) behind the new perforations.

Accordingly, an exemplary embodiment of a method of using a fluid diversion for successive downhole operations in a cased portion of a wellbore through a production zone may be performed, including the steps of (1) plugging existing perforations 509 in the liner 507 with a fluid diversion system comprising (a) a carrier fluid having an HEC gel and (b) substantially insoluble, degradable bridging particulates of different sizes, (2) perforating a new section 517 of the liner 507 to create new perforations 519, (3) fracturing the associated new region 516 of the production zone (P) that is proximate the new perforations 519, creating fractures (e.g., new near-perforation fractures 513, new near-wellbore fractures 514, and new far-field fractures 515) in the new region 516, (4) depositing proppant into the new fractures 513, 514, and 515 to prevent the fractures from closing and to create a path for hydrocarbons to migrate to and enter the wellbore 500, (5) plugging the new fractures 513, 514, and 515 and the new perforations 519 with a fluid diversion system comprising (a) a carrier fluid having an HEC gel and (b) substantially insoluble, degradable bridging particulates of different sizes, and (6) repeating steps (2) through (5) to perforate yet another new section of the liner 507 of the wellbore 500 and fracture another new region of the production zone (P) proximate the new perforations. This exemplary embodiment of a method of using a fluid diversion system for successive downhole operations can be used, in lieu of downhole flow control and isolation tools, in either new wellbore or in an existing wellbore, which has been drilled through a single production zone and lined with casing or a liner. Additionally, when a new or existing wellbore (for example a vertical wellbore) has been drilled through multiple production zones and cased with casing or liner, this exemplary embodiment of a method of using a fluid diversion for successive downhole operations may be used, in lieu of downhole flow control and isolation tools, to perforate and fracture the multiple production zones in succession. Exemplary embodiments of methods of using a fluid diversion system for successive downhole operations can thus be used to replace known operations that are referred to in the industry as “plug and perf” operations or multistage well stimulation treatments.

Therefore, the present invention is well adapted to attain the ends and advantages mentioned as well as those that are inherent therein.

The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention.

We claim:

1. A fluid diversion system for injection into a subterranean formation, the fluid diversion system comprising:
a carrier fluid comprising water; and
a dispersion comprising substantially insoluble, degradable bridging particulates in the carrier fluid;
whereby, when injected into a subterranean formation, the fluid diversion system is operative for a predetermined period of time until degradation of the substantially insoluble, degradable bridging particulates.

2. The fluid diversion system of claim 1, wherein the fluid diversion system comprises:
from about 1 wt. % to about 50 wt. % of substantially insoluble, degradable bridging particulates.

3. The fluid diversion system of claim 1, wherein the dispersion of substantially insoluble, degradable bridging particulates includes HEC particulates.

4. The fluid diversion system of claim 3, wherein the fluid diversion system comprises:
from about 1 wt. % to about 50 wt. % of substantially insoluble, degradable bridging particulates.

5. The fluid diversion system of claim 1, wherein the dispersion of substantially insoluble, degradable bridging particulates includes PLA particulates.

6. The fluid diversion system of claim 5, wherein the fluid diversion system comprises:
from about 1 wt. % to about 50 wt. % of substantially insoluble, degradable bridging particulates.

7. The fluid diversion system of claim 1, wherein the dispersion of substantially insoluble, degradable bridging particulates includes HEC particulates and PLA particulates.

8. The fluid diversion system of claim 7, wherein the fluid diversion system comprises:
from about 1 wt. % to about 50 wt. % of substantially insoluble, degradable bridging particulates.

9. The fluid diversion system of claim 1, wherein the substantially insoluble, degradable bridging particulates are in the size range from about 50 to about 4,000 microns.

10. The fluid diversion system of claim 1, further comprising sand.

11. A method of timed fluid flow control, fluid diversion, or plugging off of fractures in a subterranean formation, the method comprising:
selecting a fluid diversion system comprising: a carrier fluid comprising water; and
a dispersion in the carrier fluid, the dispersion comprising substantially insoluble, degradable bridging particulates;
injecting the selected fluid diversion system into the subterranean formation to cause fluid diversion in the subterranean formation;
producing from the subterranean formation; and
allowing an elapse of time sufficient for the injected substantially insoluble, degradable bridging particulates to degrade under conditions in the subterranean formation.

12. The method of timed fluid flow control, fluid diversion, or plugging off of fractures of claim 11, wherein the selecting comprises selecting a pre-formulated fluid diversion system, the pre-formulated fluid diversion system prepared remotely from a site where the step of injecting the fluid into a subterranean formation is performed.

13. The method of timed fluid flow control, fluid diversion, or plugging off of fractures of claim 11, wherein the step of selecting comprises selecting a fluid diversion system comprising:
from about 1 wt. % to about 50 wt. % of the substantially insoluble, degradable bridging particulates.

14. The method of timed fluid flow control, fluid diversion, or plugging off of fractures of claim 11, wherein the fluid diversion system further comprises HEC cross-linked polymer.

15. The method of timed fluid flow control, fluid diversion, or plugging off of fractures of claim 14, wherein the step of selecting comprises selecting a fluid diversion system comprising from about 1 wt. % to about 50 wt. % of substantially insoluble, degradable bridging particulates of PLA.

16. The method of timed fluid flow control, fluid diversion, or plugging off of fractures of claim 14, wherein the step of selecting comprises selecting a fluid diversion system comprising from about 1 wt. % to about 50 wt. % of substantially insoluble, degradable bridging particulates, said particulates including HEC particulates and PLA particulates.

17. The method of timed fluid flow control, fluid diversion, or plugging off of fractures of claim 14, wherein the step of selecting comprises selecting a fluid diversion system comprising from about 1 wt. % to about 50 wt. % of substantially insoluble, degradable bridging particulates of HEC.

18. The method of timed fluid flow control, fluid diversion, or plugging off of fractures of claim 11, wherein the substantially insoluble, degradable bridging particulates are in the size range from about 50 to about 4,000 microns.

19. A fluid diversion system for injection into a subterranean formation, the fluid diversion system comprising:
a carrier fluid comprising water;
a cross-linked polymer dissolved or dispersed in the carrier fluid; and
from about 1 wt. % to about 50 wt. % of substantially insoluble, degradable bridging particulates in a size range from about 50 to about 4,000 microns dispersed in the carrier fluid;
whereby, when injected into the subterranean formation, the fluid diversion system is operative as a diversion fluid for a predetermined period of time, until degradation of the substantially insoluble, degradable bridging particulates under conditions in the subterranean formation.

20. The fluid diversion system of claim 19, wherein the predetermined period of time is from about 8 to about 120 hours.

21. The fluid diversion system of claim 20, wherein the substantially insoluble, degradable bridging particulates includes HEC particulates and PLA particulates; and wherein the cross-linked polymer comprises HEC.

22. A method of conducting re-fracturing operations in a wellbore drilled through a production zone of a subterranean formation, the wellbore being lined with a liner proximate the production zone, the method of conducting re-fracturing operations comprising the steps of:
selecting a fluid diversion system comprising a carrier fluid and a dispersion therein of substantially insoluble, degradable bridging particulates;
pumping the fluid diversion system into the wellbore and into a plurality of pre-existing perforations located in a first section of the liner proximate a first region of the production zone;
plugging the plurality of pre-existing perforations in the first section of the liner with the fluid diversion system;
perforating a second section of the liner to create a plurality of new perforations located in the second section of the liner; and
initiating fractures within a second region of the production zone by pumping fluid through the plurality of new perforations and into the second region of the production zone;
whereby, when pumped into the plurality of pre-existing perforations, the fluid diversion system is operative for plugging the pre-existing perforations for a predetermined period of time until degradation of the substantially insoluble, degradable bridging particulates.

23. A method of conducting re-fracturing operations in an open wellbore drilled through a production zone of a subterranean formation, the production zone having pre-existing fractures, the method of conducting re-fracturing operations comprising the steps of:
selecting a fluid diversion system comprising a carrier fluid and a dispersion therein of substantially insoluble, degradable bridging particulates;
pumping the fluid diversion system into the open wellbore and into the pre-existing fractures located in the production zone;
plugging the plurality of pre-existing fractures located in the production zone with the fluid diversion system; and
initiating new fractures within the production zone by pumping fluid into the production zone;
whereby, when pumped into the plurality of pre-existing fractures, the fluid diversion system is operative for plugging the pre-existing fractures for a predetermined period of time until degradation of the substantially insoluble, degradable bridging particulates.

24. A method of conducting multi-stage fracturing operations in a wellbore drilled through a subterranean formation, the wellbore being lined with a liner, the method of conducting multi-stage fracturing operations comprising the steps of:
perforating a first section of the liner to create a first set of perforations in the liner;
initiating fractures within the subterranean formation proximate the first set of perforations in the liner by pumping fluid through the first set of perforations and into a first region of the subterranean formation proximate the first set of perforations;
selecting a fluid diversion system comprising a carrier fluid and a dispersion therein of substantially insoluble, degradable bridging particulates;
pumping a volume of the fluid diversion system into the wellbore and into the first set of perforations located in the first section of the liner;
plugging the first set of perforations in the first section of the liner with at least a portion of the fluid diversion system;
perforating a second section of the liner to create a second set of perforations in the liner; and
initiating fractures within the subterranean formation proximate the second set of perforations in the liner by pumping fluid through the second set of perforations and into a second region of the subterranean formation proximate the second set of perforations;
whereby, when pumped into the first set of perforations, the fluid diversion system is operative for plugging the first set of perforations for a predetermined period of time until degradation of the substantially insoluble, degradable bridging particulates.
